(19) United States
(12) Patent Application Publication
(10) Pub. No.: US 2014/0019467 A1
(43) Pub. Date: Jan. 16, 2014

(54) METHOD AND APPARATUS FOR PROCESSING MASKED DATA

(71) Applicant: FUJITSU LIMITED, Kawasaki-shi (JP)

(72) Inventors: Kouichi ITOH, Kawasaki (JP); Hiroshi TSUDA, Fujisawa (JP); Mebae USHIDA, Kawasaki (JP)

(73) Assignee: FUJITSU LIMITED, Kawasaki-shi (JP)

(21) Appl. No.: 14/029,978

(22) Filed: Sep. 18, 2013

Related U.S. Application Data
(63) Continuation of application No. PCT/JP2011/056594, filed on Mar. 18, 2011.

(51) Int. Cl. G06F 7/76

(52) U.S. Cl. CPC G06F 7/764
USPC 707/757

(57) ABSTRACT

A disclosed method includes: generating a predetermined number of sets, wherein each of the sets includes n mask values and n is the number of attributes to be masked in a database; selecting, for each record of a plurality of records, which includes attribute values of the attributes to be masked, one set of the predetermined number of sets; and performing, for each record of the plurality of records, a predetermined operation for the selected one set of the n mask values and the attribute values of the attributes to be masked in the record to generate masked data for the plurality of records.

### CROSS-REFERENCE TO RELATED APPLICATIONS

This application is a continuing application, filed under 35 U.S.C. section 111(a), of International Application PCT/JP2011/056594, filed on Mar. 18, 2011.

### FIELD

This technique relates to a data masking technique.

### BACKGROUND

The data mining technique is a technique that uses a computer to find the correlation among data that is included in a large quantity of data stored in a database. By using this technique, it is possible to find the correlation between data even among large amounts of data that would be impossible for a person to process. A typical example of a method for using the data mining technique is finding combinations of products that a consumer purchases, and by using this data mining technique, it is possible to find a correlation that the frequency that a consumer who purchases disposable diapers also purchases beer is high, and by displaying these products having a high correlation near each other in a store, an increase in sales can be anticipated.

In the past, when performing the data mining, data was collected and analyzed using an in-house computer. However, in the future, as cloud computing spreads, it is expected that methods for obtaining good analysis results while keeping down the cost of maintaining a system by collecting and analyzing data in an external cloud computing environment will become mainstream. However, by entrusting data collection and analysis to an external cloud computing environment, there is a known problem that even though it is possible to reduce costs, there is also a fear concerning privacy. In other words, in a conventional data mining, the processing is performed in an in-house closed computer environment, and it is difficult for confidential information to be leaked, however, in the data mining that uses cloud computing, an open computer environment that is used by many users is used, so it is presumed that the risk of leaking confidential information increases.

Privacy Preserving Data Mining (hereafter, referred to as PPDM) is known as a conventional technique for achieving safe analysis even in an open environment such as cloud computing.

In PPDM, various implementation methods are known. A method of randomizing data is known as a typical method.

In PPDM that uses this randomization of data, original data is not stored as is in a database for a database table that is used in data analysis, but data obtained by adding random numbers to the original data is stored in the database. As illustrated in FIG. 1A, the original database includes plural records, each of which includes attribute values of attributes such as name, address and age. On the other hand, as illustrated in FIG. 1B, by adding random numbers (R1 to R5, S1 to S5 and T1 to T5) to each of the attribute values in each record to mask the original data, leaking of confidential data from the individual records in the database is prevented.

The random numbers that are used to mask the data are called “mask values”, however, by keeping the statistical characteristics of the “mask values” less than the statistical characteristics of the overall database, it is also possible to obtain necessary analysis information from a database that is masked using random numbers. Therefore, it is possible to perform analysis of the overall trends to be found by the data mining. For example, by adding random numbers in the range from −5 to +5 to data having the attribute “age”, it is possible to perform trend analysis for the characteristics of the rough ages such as “twenties” and “thirties” while masking the data of the individual records. However, in PPDM that uses this randomization of data, two problems that are described below are known.

(A) Decrease in Analysis Precision

Data is masked, so basically, as the analysis precision decreases, depending on the type of data being analyzed or the type of analysis algorithm used, there is a further serious decrease in the analysis precision. For example, in the case of a mask in which random numbers in the range from −5 to +5 are added to data having the attribute “age”, it is possible to perform trend analysis for the rough age characteristics such as the “twenties” and “thirties”, however, when compared with the case of performing data analysis using the “age” attribute with no masking, there is a relative decrease in analysis precision.

However, even though there is the merit of being able to perform trend analysis for the rough age characteristics such as the “twenties” and “thirties”, having this merit is due to the fact that age is an attribute called a “numerical attribute”. The “numerical attribute” is an attribute having a magnitude relationship between data that represents an attribute. For example, “numerical attributes” correspond to data such as “age”, “height”, “weight”, “income” and the like, which represent a numerical value. A characteristic of the numerical attributes is that it is possible to perform rough trend analysis even when using a value that is shifted a little from the true value. On the other hand, attributes that are called “category attributes” are attributes that do not have a magnitude relationship between data values that represent an attribute, and for example, is data that represents a type such as a “name”, “gender”, “product name”, “occupation” and the like. A characteristic of the category attributes is that the analysis is difficult when the value is shifted even a little from the true value. Particularly, when an analysis algorithm that is called Apriori, and is used to find the correlation between types of products that a consumer purchases is executed on data that includes category attributes, there is a problem in that the analysis precision becomes very bad. The reason for this is that the basic algorithm of Apriori counts the frequency of the occurrences of correlation between attributes in each record, however, in PPDM that uses the randomization of data, masking of attributes is performed by using random numbers with no correlation. In other words, the correlation in identical records is disrupted using random numbers, so it becomes impossible to collect data having an effective correlation.

More specifically, as illustrated in FIG. 2, in plural records that include the attributes gender, age, purchased product 1 and purchased product 2, random numbers R1 to R5 are added to the attribute values for gender, random numbers S1 to S5 are added to the attribute values for age, random numbers T1 to T5 are added to the attribute values for purchased product 1, and random numbers U1 to U5 are added to the attribute values for purchased product 2. Even for attribute values in the same record, the random numbers that are added are values that are not correlated at all, so a problem such as described above occurs.

(B) Cost of Inversely Converting to Original Data is High Furthermore, when using PPDM that uses the randomization of data when individually referencing original data (in other words, true data values) before masking for a purpose other than the analysis, there is a problem in that the cost for inversely converting to the original data is high. In other words, all of the data that is to be concealed is masked using random numbers that are not correlated with each other, so as illustrated in FIG. 3, in order to return to the state before the mask by performing unmasking, data of all of the mask values are saved, separately. That is, the amount of data in the database is doubled, so the cost becomes high.

Here, the Apriori algorithm mentioned above will be explained.

The Apriori algorithm is a typical algorithm that is used in analysis of consumer behavior, and by using this algorithm, it is possible to find a correlation that the frequency that a consumer who purchases disposable diapers will also purchase beer is high. By counting the number of combinations of items that appear in a table of a database, the correlation between data in the database is analyzed.

In the following, the processing by the Apriori algorithm will be explained in detail using a simple sample. For example, in the following, a table such as illustrated in FIG. 4 will be processed. In the example in FIG. 4, each record gives a list of products that were purchased by a consumer, and for example, a customer having a customer ID “3021” purchased beer, edamame, batteries and disposable diapers, and a customer having a customer ID “3022” purchased beef, a shirt and disposable diapers.

From this table, in order to analyze the correlation of the combination of purchased products, the Apriori algorithm executes a count of the item sets. An item set is an arbitrary combination of products purchased by each consumer. For example, {beer, edamame}, {batteries, beef, shirt}, {beer, beef, batteries, disposable diapers} and the like are combinations of arbitrary purchased products. In the Apriori algorithm, a count of item sets having a high frequency of appearance is executed among these combinations. For example, {beer, edamame} appears for customers “3021”, “3023” and “3025”, so this item set has a high frequency of appearance for 3 out of 5 customers, however, {beer, batteries} is an item set having a low frequency of appearance and only appears for customer ID “3021”. The purpose of the Apriori algorithm is to find item sets having a high frequency of appearance.

In the Apriori algorithm, in order to find an item set having a high frequency of appearance, the frequency of appearance is counted while increasing the number of items that are included in the item set one at a time. This takes advantage of the characteristic that when the frequency of appearance of the single item {beer} is less, the frequency of appearance of the combination {beer, edamame} also becomes lesser. In the case where the frequency of appearance of the single produce {beer} is high, there is a possibility that the frequency of appearance of {beer, edamame} in which one more item is added will also be high. When the result of counting the frequency of appearance of {beer, edamame} is sufficiently high, there is a similarly good possibility that the frequency of appearance of {beer, edamame, disposable diapers} in which one more item is added will also be high.

In this way, the frequency of appearance is counted while increasing the items one at a time. When a typical database table is used, counting the frequency of appearance of combinations of arbitrary items results in an exponential calculation cost increase, so is not practical, however, in the Apriori algorithm, by counting while increasing the items a little at a time, efficient counting of the frequency of appearance is achieved.

For the table illustrated in FIG. 4, the process of executing the counting by the Apriori algorithm is illustrated in FIGS. 5A to 5H. In the following, in order to simplify the explanation, beer=A, edamame=B, batteries=C, beef=D, shirt=E and disposable diapers=F are used. FIG. 5A is a re-expression of FIG. 4 using ABCDEF as described above. By counting the frequency of appearance of single items, results as illustrated in FIG. 5B are obtained. Here, the frequency of C is less, so it is removed. As a result, item sets having two items are generated as illustrated in FIG. 5C. By counting the frequency of appearance for each item set that is generated in this way, results as illustrated in FIG. 5D are obtained. Therefore, as illustrated in FIG. 5E, item sets having a high frequency of appearance (two or more) are identified to be {A, B}, {A, D}, {A, F}, {B, D}, {B, F}, {D, E} and {D, F}. When item sets having three items are generated from these item sets, the results are as illustrated in FIG. 5F. By counting the frequency of appearance for each item set, results as illustrated in FIG. 5G are obtained. From the results illustrated in FIG. 5G, by extracting item sets having a high frequency of appearance (two or more), item sets as illustrated in FIG. 5H are obtained. In other words, {A, B, D}, {A, B, F} and {B, D, F} are obtained.

After such counting the frequency of appearance is finished, it is simple to find the correlation between items. This is because the fact that {A, B, F} appears two times and {A, B} appears three times means that the probability that {A, B, F} appears in case of {A, B} is 2/3.

In a case of presuming A and B, being able to expect a high probability of result F is notated by the expression “A & B->F”. In other words, this can lead to the conclusion that there is a high probability 2/3 that consumers that purchase {A, B}={beer, edamame} (occupy a large ratio, 3/5 for all) will purchase {A, B, F}={beer, edamame, disposable diapers}. The correlation of combinations of other purchased products can be similarly derived by using other combinations of item sets having a high frequency of appearance.

In the Apriori algorithm, the analysis is executed in this way based on the count of the frequency of appearance of combinations of items such as {A, B, F}. This combination of items is the combination of attribute values for “purchased product 1”, “purchased product 2”, “purchased product 3” and “purchased product 4”, which are illustrated in FIG. 4. In other words, the Apriori algorithm is based on the process of counting the frequency of appearance of combinations of attribute values in respective records in a database. Therefore, in the case of using conventional PPDM such as illustrated in FIG. 2, the attribute values are masked by random numerical values that are not correlated with each other, and the count result is completely randomized, so it is not possible to obtain adequate analysis results.

Namely, there is no technique for appropriately carrying out an analysis processing while keeping data secrecy.

### SUMMARY

A data processing method relating to a first aspect of this technique includes: (A) generating a predetermined number of sets, wherein each of the sets includes n mask values and n is the number of attributes to be masked in a database; (B) selecting, for each record of a plurality of records, which includes attribute values of the attributes to be masked, one set of the predetermined number of sets; and (C) performing, for each record of the plurality of records, a predetermined operation for the selected one set of the n mask values and the attribute values of the attributes to be masked in the record to generate masked data for the plurality of records.

A data processing method relating to a second aspect of this technique includes: (A) obtaining one set that has a highest appearance probability from among a predetermined number of sets, wherein each of the sets includes n mask values and n is the number of attributes to be masked in a database; and (B) performing, for each of a plurality of analysis data sets, each of which includes masked attribute values, an inverse mask operation of a predetermined mask operation for a masked attribute value in the analysis data set and a corresponding mask value in the obtained one set, to generate unmasked data.

A data processing method relating to a third aspect of this technique includes: (A) performing, for each analysis data set of a plurality of analysis data sets, each of which includes masked attribute values, an inverse mask operation of a predetermined mask operation for the masked attribute values and corresponding mask values included in each set of a predetermined number of sets, each of which includes n mask values, wherein the n is the number of attributes to be masked in a database, to generate the predetermined number of unmasked analysis data sets for each of the plurality of analysis data sets; (B) correlating each of the predetermined number of unmasked analysis data sets with an appearance frequency corresponding to the analysis data set used in the performing to generate the predetermined number of unmasked analysis data sets; (C) collecting same unmasked analysis data sets to sum appearance frequencies correlated with the same unmasked analysis data sets; and (D) storing data representing a type of the same unmasked analysis data sets and summed appearance frequencies.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIGS. 1A and 1B are diagrams to explain a conventional art;

FIG. 2 is a diagram to explain the conventional art;

FIG. 3 is a diagram to explain the conventional art;

FIG. 4 is a diagram to explain the conventional art;

FIG. 5A is a diagram to explain Apriori algorithm;

FIG. 5B is a diagram to explain Apriori algorithm;

FIG. 5C is a diagram to explain Apriori algorithm;

FIG. 5D is a diagram to explain Apriori algorithm;

FIG. 5E is a diagram to explain Apriori algorithm;

FIG. 5F is a diagram to explain Apriori algorithm;

FIG. 5G is a diagram to explain Apriori algorithm;

FIG. 5H is a diagram to explain Apriori algorithm;

FIGS. 6A and 6B are diagrams to explain an embodiment of this technique;

FIG. 7 is a diagram to explain an effect of this embodiment;

FIG. 8 is a diagram illustrating a system outline of this embodiment;

FIG. 9 is a functional block diagram of a user terminal;

FIG. 10 is a diagram to explain a processing by an initial processing unit;

FIG. 11 is a diagram depicting a processing flow of a masking processing in a first embodiment;

FIG. 12 is a diagram depicting a processing flow of an unmasking processing in the first embodiment;

FIG. 13 is a diagram depicting a processing flow of the unmasking processing in the first embodiment;

FIG. 14 is a diagram to explain an outline of the unmasking processing in the first embodiment;

FIG. 15 is a diagram depicting a processing flow of the masking processing in a second embodiment;

FIG. 16 is a diagram to explain an outline of an unmasking processing in the second embodiment;

FIG. 17 is a diagram depicting a processing flow of the unmasking processing in the second embodiment;

FIG. 18 is a diagram depicting a processing flow of the unmasking processing in the second embodiment;

FIG. 19 is a diagram depicting a processing flow of the unmasking processing in the second embodiment;

FIG. 20A is a diagram to explain cross tabulation;

FIG. 20B is a diagram to explain the cross tabulation;

FIG. 20C is a diagram to explain the cross tabulation;

FIG. 21 is a diagram illustrating an outline of an unmasking processing in a third embodiment; and

FIG. 22 is a functional block diagram of a computer.

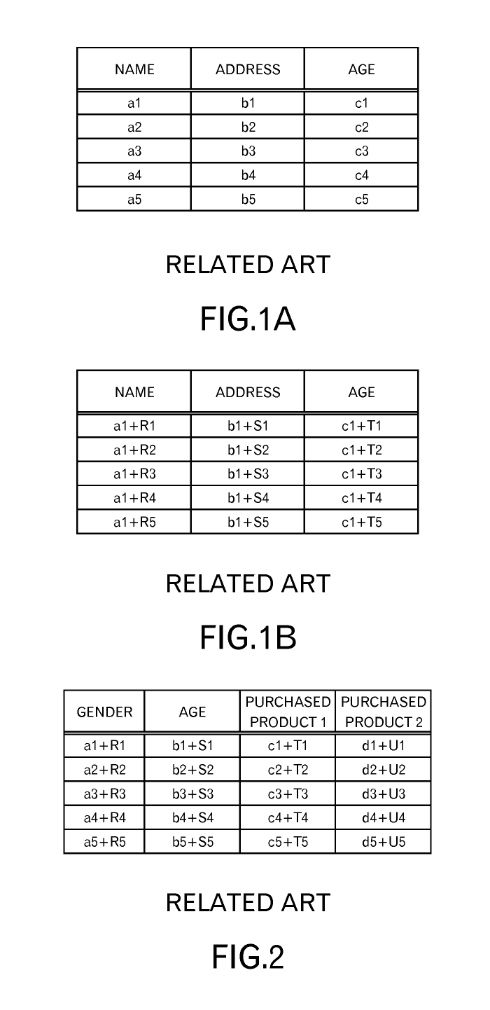

### DESCRIPTION OF EMBODIMENTS

First, the processing that is performed in an embodiment of this technique will be simply explained.

A conventional mask processing gave random numbers to values to be masked, independently among attributes as illustrated in FIG. 2. As a result, the correlation between attributes is disrupted, and it was not possible to obtain adequate analysis results. On the other hand, as illustrated in FIG. 6A and FIG. 6B, in an embodiment of this technique, N mask value sets, each of which includes plural mask values, are prepared in advance, then one of these is selected for each row (i.e. record) of the database by a random number, and the record is masked by the selected mask value set.

A mask value set is expressed as one set of mask values for attributes to be masked. For example, as illustrated in FIGS. 6A and 6B, in the case where there are three types of attributes to be masked, when switching two kinds of mask value sets using random numbers, two kinds of mask value sets, {F₁, G₁, H₁} and {F₂, G₂, H₂} are prepared as illustrated in FIG. 6B. However, {F₁, G₁, H₁} and {F₂, G₂, H₂} are all constant values. F₁ and F₂ are mask values for masking the first attribute, G₁ and G₂ are mask values for masking the second attribute, and H₁ and H₂ are mask values for masking the third attribute, and for each row, either {F₁, G₁, H₁} or {F₂, G₂, H₂} is selected by a random number and used as the mask for attribute values.

By using mask values that are linked between attributes such as {F₁, G₁, H₁} and {F₂, G₂, H₂}, it is possible to mask the correlation between attributes while saving the state shifted by the mask values at the same time, so even in the case of using the Apriori algorithm or the like, there is no decrease in the analysis precision.

Here, the reason that a decrease in analysis precision is suppressed will be explained. For example, as a counting result obtained by applying the Apriori algorithm on a normal table for which masking has not been performed, it is presumed that the frequency of appearance of {A, B, D} was 10 times. Here, by using a method of selecting one of two types of mask value sets {F₁, G₁, H₁} and {F₂, G₂, H₂} using random numbers, {A+F₁, B+G₁, D+H₁} and {A+F₂, B+G₂, D+H₂} appeared a total of ten times. In the case where the random numbers are unbiased, each masked record appears 5 times as an average.

In order to cancel this kind of masking and obtain unmasked count results, {F₁, G₁, H₁} and {F₂, G₂, H₂} are used, and, when knowing these values, it is possible to obtain the unmasked count results. The method for obtaining the unmasked count results will be explained in detail later.

Therefore, by utilizing the characteristic that the values {F₁, G₁, H₁} and {F₂, G₂, H₂} are used to unmask the count results, it is possible to achieve safe data mining using these values as a key. In other words, by performing the analysis processing in the masked state, the analysis is completely performed in an open environment, and by performing unmasking of the obtained analysis results, it is possible to obtain adequate analysis results. By performing the analysis processing that requires the high processing performance of the computers in a cloud computing environment, it is possible to keep down main system costs, and then, after the computed results have been outputted, by performing decoding in a safe in-house closed computing environment, it is possible to reduce system costs and prevent the leaking of confidential information.

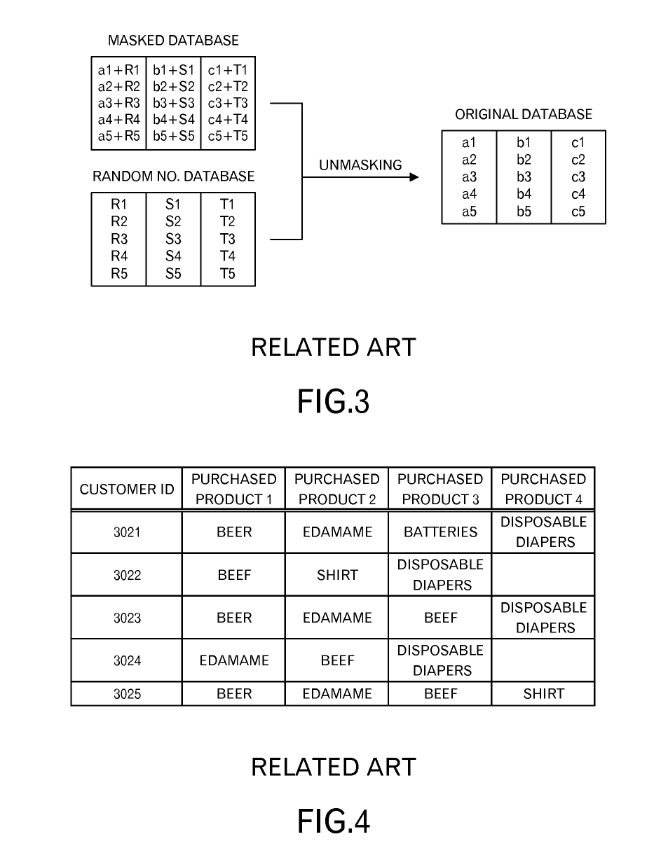

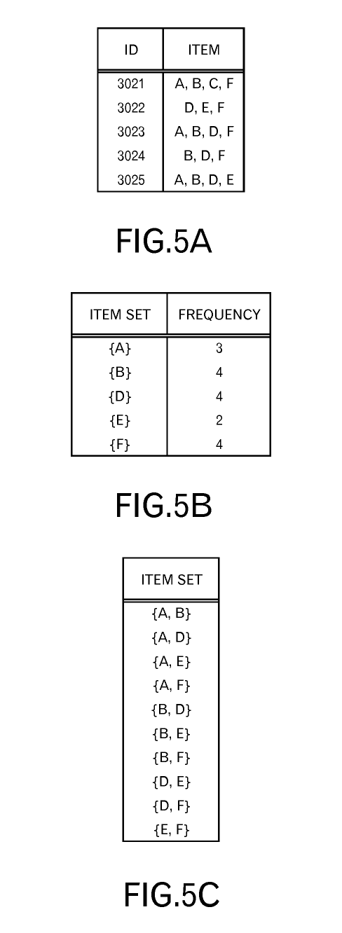

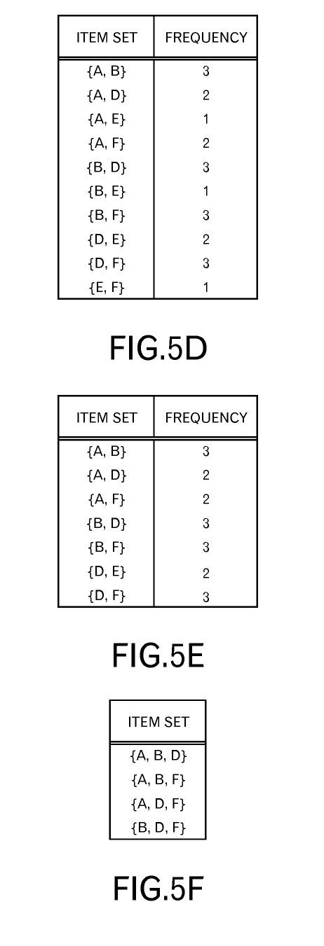

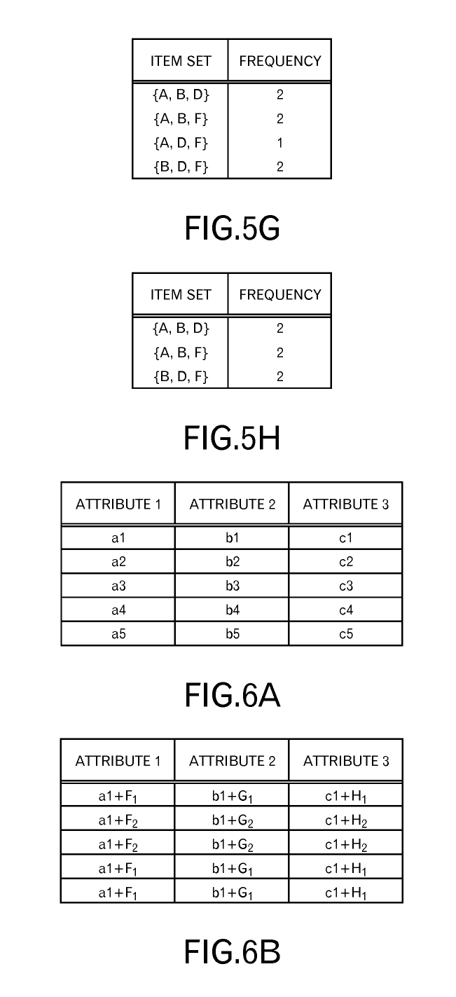

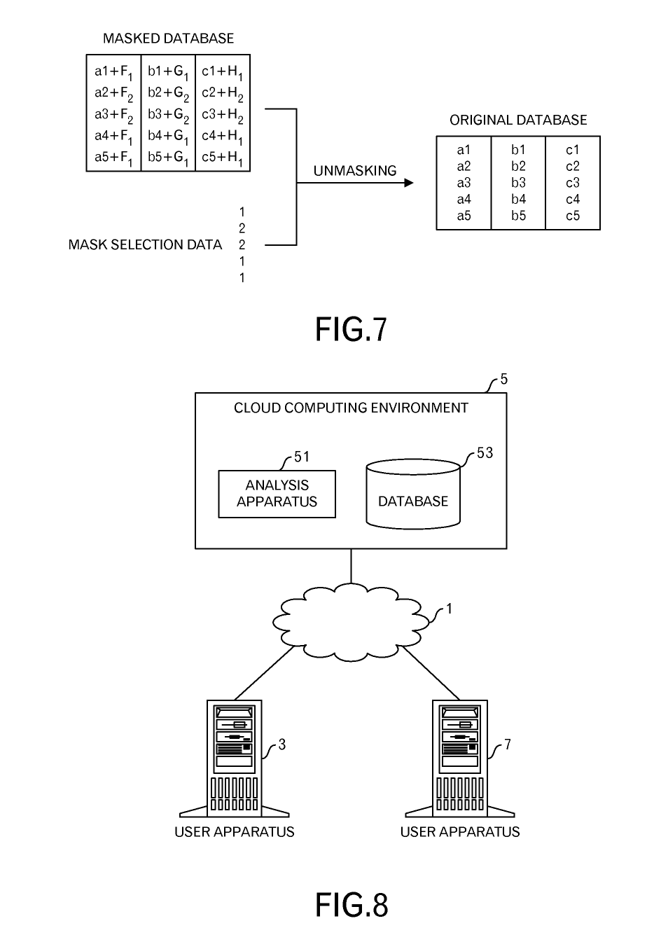

Furthermore, in this embodiment, the cost for inversely converting to original data is reduced. In other words, as illustrated in FIG. 3, in the case of using PPDM by a conventional method, a table of masked data, and a table of mask values that is nearly the same size are stored, however, as schematically illustrated in FIG. 7, instead of the table of mask values, mask selection data that represents which mask value set has been selected, and data of the mask value set that was used is saved. Unlike in the method of saving a mask value table, the amount of data for saving the mask selection data is very small, so it is possible to reduce the cost of inversely converting to the original data.

### Embodiment 1

FIG. 8 illustrates a system configuration relating to this embodiment. In this embodiment, a cloud computing environment 5, which provides a data analysis service by way of a network 1 such as the Internet, is provided for plural users. Each user connects the respective user apparatuses 3 and 7 to the network 1, and uses the cloud computing environment 5 using the user apparatuses 3 and 7.

The cloud computing environment 5 has a database 53 that stores data that is received from the user apparatuses 3 and 7, and an analysis apparatus 51 that performs various kinds of analysis processing. In this embodiment, the analysis processing that is performed by the analysis apparatus 51 includes various kinds of analysis processing such as other cross tabulation in addition to the Apriori algorithm, and is the same as that performed conventionally.

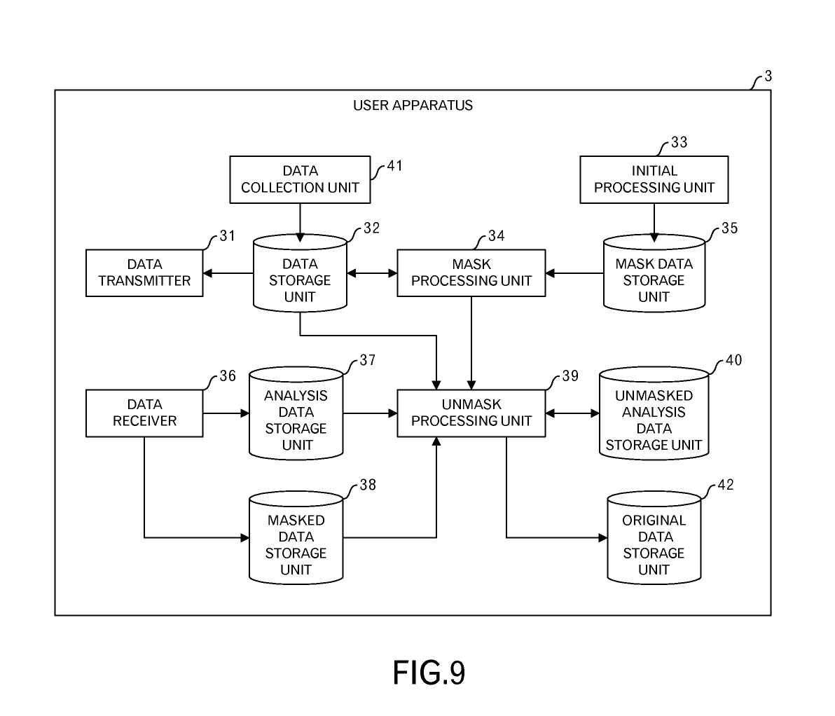

FIG. 9 is a function block diagram illustrating the functions of the user apparatus 3. The user apparatus 3 has a data transmitter 31, a data collection unit 41, a data storage unit 32, an initial processing unit 33, a mask data storage unit 35, a mask processing unit 34, a data receiver 36, an analysis data storage unit 37, a masked data storage unit 38, an unmask processing unit 39, an unmasked analysis data storage unit 40, and an original data storage unit 42.

The data collection unit 41 performs a processing to collect original data, and stores the collected original data in the data storage unit 32. The data in the user's system may be automatically collected in this way, and may be stored in the data storage unit 32 in response to an instruction from the user.

The initial processing unit 33 generates mask value sets according to a setting or an instruction from the user, and stores that mask value sets in the mask data storage unit 35. The mask processing unit 34 performs a mask processing by using the mask value sets that are stored in the mask data storage unit 35, and stores the masked data in the data storage unit 32. The masked data may be stored so as to replace the original data, or may be stored in a separate area. The mask processing unit 34 also stores the mask selection data described above in the data storage unit 32. The mask selection data may also be stored in a separate data storage unit. The data transmitter 31 stores the masked data in a database 53 in the cloud computing environment 5 by way of the network 1.

On the other hand, in response to an instruction from the user apparatus 3, an instruction from a user terminal that is connected to the network 1, or periodically, the analysis apparatus 51 performs a predetermined analysis processing as described above for the masked data that is stored in the database 53 and generates masked analysis data, then transmits that data to the user apparatus 3.

The data receiver 36 of the user apparatus 3 stores the received analysis data in the analysis data storage unit 37. The unmask processing unit 39 uses the mask value sets that are stored in the mask data storage unit 35, and performs an unmask processing that will be explained below on the masked analysis data that is stored in the analysis data storage unit 37, then stores the processing result in the unmasked analysis data storage unit 40.

It is not the main purpose of this embodiment, however, when it is desired to restore the original data, the data receiver 36 reads the masked data from the database 53, and stores that masked data in the masked data storage unit 38. The unmask processing unit 39 uses the mask value sets that are stored in the mask data storage unit 35 and the mask selection data that is stored in the data storage unit 32 to perform inverse computation of the masking processing on the masked data that is stored in the masked data storage unit 38, and then stores the processing results, which are the original data, in the original data storage unit 42. In this embodiment, the original data is data in a database 53 that includes plural records.

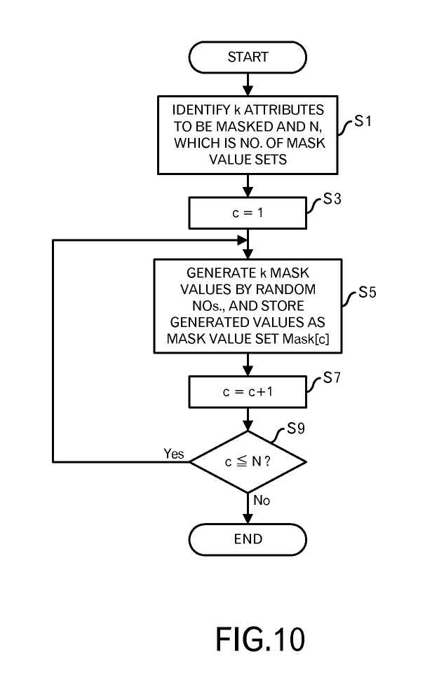

Next, the processing by the initial processing unit 33 relating to this embodiment will be explained using FIG. 10. The initial processing unit 33 identifies K, which is the number of attributes to be masked, and N, which is the number of mask value sets, based on a user instruction or setting (step S1). Then, the initial processing unit 33 initializes a counter c to “1” (step S3). Furthermore, the initial processing unit 33 generates k mask values using random numbers, and stores those mask values in the mask data storage unit 35 as a mask value set Mask [c]={M_{c,1}, M_{c,2}, . . . M_{c,k}} (step S5).

The initial processing unit 33 then increments c by “1” (step S7), and determines whether c is equal to or less than N (step S9). When c is equal to or less than N, the processing returns to the step S5. On the other hand, when c is greater than N, the processing ends.

By performing this kind of processing, N sets of mask value sets, each of which includes k random numbers, are generated and stored in the mask data storage unit 35. The k random numbers are used for k attributes to be masked.

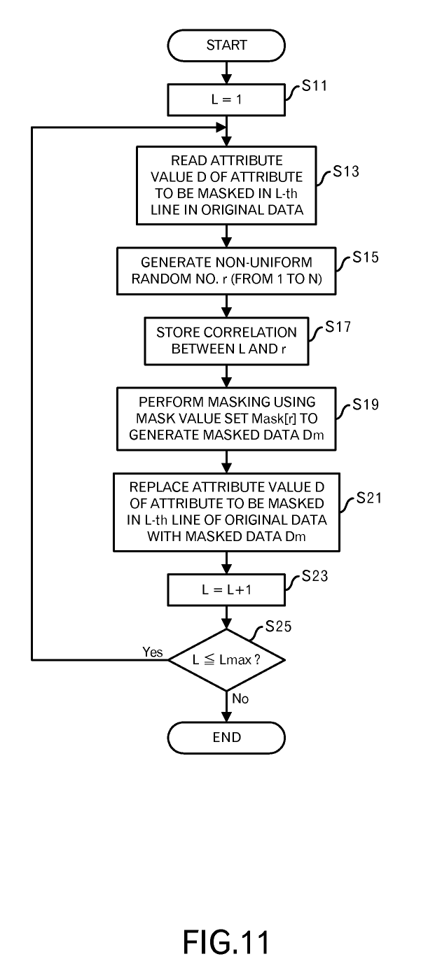

Next, the processing by the mask processing unit 34 will be explained by using FIG. 11. First, the mask processing unit 34 initializes a counter L for the records included in the original data that is stored in the data storage unit 32 to “1” (step S11). Then the mask processing unit 34 reads the attribute values D of the attributes that are to be masked and that are in the L-th line of the original data from the data storage unit 32 (step S13). As described above, there are k attributes to be masked, so D={Data_{L,1}, Data_{L,2}, . . . Data_{L,k}} is read.

The mask processing unit 34 also generates a random number r within a range from 1 to N according to a certain distribution (step S15). The certain distribution is a distribution where the probability of r=s is the highest. This is for the unmask processing that will be explained below. The mask processing unit 34 stores the correlation between L and r in the data storage unit 32 as mask selection data (step S17). As a result, it is possible to restore the original data.

Furthermore, the mask processing unit 34 generates masked data Dm by performing the masking using mask value set Mask[r] (step S19). Mask[r]={M_{r,1},M_{r,2},M_{r,k}} is read out from the mask data storage unit 35, and Dm={f(Data_{L,1},M_{r,1}),f(Data_{L,2},M_{r,2}), . . . f(Data_{L,k},M_{r,k})} is generated.

Here, when the relationship between x and z is a bijection relationship, the function f(x, y)=z is any function. In other words, for a function f that calculates z from x as given by f(x, y)=z, there should be an inverse function f⁻¹ given by f⁻¹(z, y)=x that uniquely determines x from z. An example of this kind of function is given below.

Addition: z=f(x,y)=x+y,f⁻¹(z,y)=z−y=x

Addition and remainder: z=f(x,y)=x+y(mod T),f⁻¹(z,y)=z−y(mod T)=x

Subtraction: z=f(x,y)=x−y,f⁻¹(z,y)=z+y=x

Subtraction and remainder: z=f(x,y)=x−y(mod T),f⁻¹(z,y)=z+y(mod T)=x

Exclusive disjunction (XOR): z=f(x,y)=xXORy,f⁻¹(z,y)=zXORy=x

Multiplication: z=f(x,y)=x*y,f⁻¹(z,y)=z/y=x

Multiplication and remainder: z=f(x,y)=x*y(mod T),f⁻¹(z,y)=z*y⁻¹(mod T)=x

T is a constant, and, for example, a constant such as T=2³², which expresses the number of data patterns of word values, is used. The aforementioned function may be another function, however, preferably is a function as simple of an operation as possible. This is because f(x, y) expresses an operation for masking a database, however in the data mining, depending on the use, data that is inputted to the database is collected in real-time, and the amount of that data becomes extremely large. For example, when measurement data that is collected from many sensing devices that are located around the world is masked and stored in a database in real-time, and the computing process for f(x, y) takes a large amount of time, there is a large load on the masking processing, and the capability to collect data in real-time is lost. Therefore, the function f(x, y) for the masking processing is preferably a simple operation such as given in the example above.

After that, the mask processing unit 34 replaces the attribute values D of the attributes in the L-th row of the original data to be masked, with the masked data Dm (step S21). Here, the case is illustrated in which the original data is not stored inside the user apparatus 3, and when the original data is stored, the masked data and the attribute values of the attributes other than the attributes to be masked are stored in a separate area at the step S21. After that, the mask processing unit 34 increments L by “1” (step S23), and determines whether L is equal to or less than the number of records Lmax in the original data (step S25). When L is equal to or less than Lmax, the processing returns to the step S13. However, when L is greater than Lmax, the processing ends.

By performing this kind of processing, it is possible to mask the attribute values of the attribute to be masked. Moreover, when doing this, the attribute values of the attributes in the record to be masked are masked by mask values that have a correlation, so it is possible to adequately perform the analysis processing. The size of the mask selection data for restoring the original data is also small, so it is possible to reduce the storage capacity for the mask selection data.

The analysis processing is a processing, for example, according to the Apriori algorithm, and an explanation is omitted here. In other words, the analysis processing is performed as was done conventionally while data is being masked, so the analysis results are also masked.

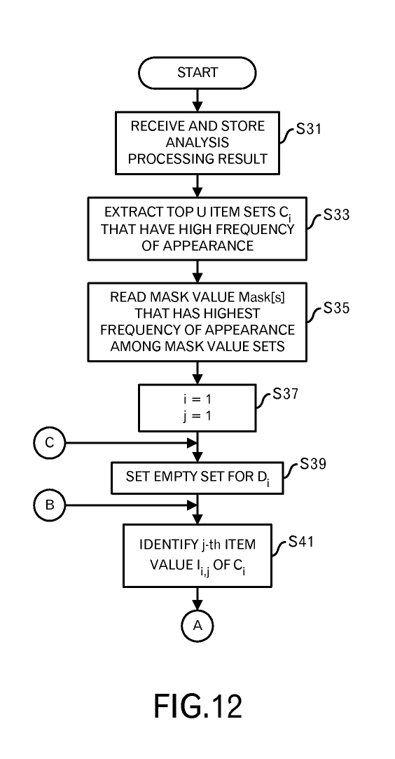

Next, the processing for unmasking will be explained using FIG. 12 to FIG. 14. First, the data receiver 36 receives analysis data, which is the result of the analysis processing, from the analysis apparatus 51, and stores that analysis data in the analysis data storage unit 37 (step S31). The analysis data is masked, and includes data for item sets and the frequencies of appearance thereof in the case of the Apriori algorithm.

Then, the unmask processing unit 39 extracts the top U item sets C₁ having a high frequency of appearance from the analysis data stored in the analysis data storage unit 37 (step S33). The item sets are expressed as described below.

C₁={I_{1,1},I_{1,2}, . . . I_{1,max}_{_{—}}₁}

C₂={I_{2,1},I_{2,2}, . . . I_{2,max}_{_{—}}₂}

C_{U}={I_{U,1},I_{U,2}, . . . I_{U,max}_{_{—}}_{U}}

The unmask processing unit 39 also reads the mask value set Mask[s] having the highest frequency of appearance from the mask value sets that are stored in the mask data storage unit 35 (step S35).

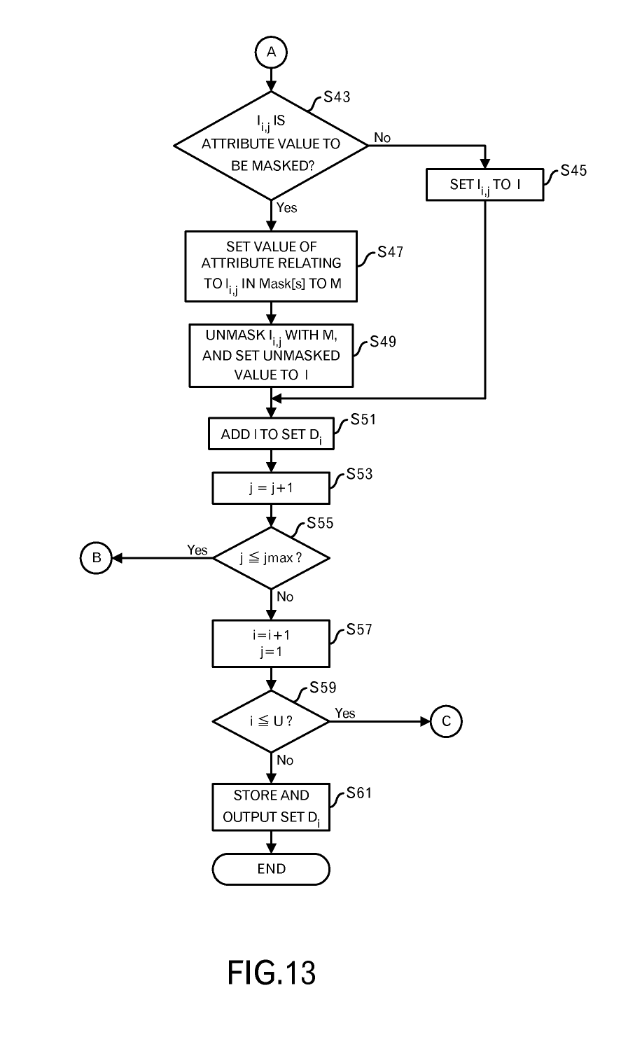

Moreover, the unmask processing unit 39 initializes a counter i for the item set and a counter j for the item to “1” (step S37). Furthermore, the unmask processing unit 39 sets an empty set for the unmask analysis data D₁ (step S39). Then, the unmask processing unit 39 identifies the j-th item value of the item set C₁ (step S41). The processing then moves to the processing in FIG. 13 by way of terminal A.

Shifting to an explanation of the processing in FIG. 13, the unmask processing unit 39 determines whether or not I is an attribute value of the masked attributes (step S43). For example, items such as A, B, C and the like, which are handled in the Apriori algorithm, are expressed above as attribute values for simplification (for example, the two types of attribute values “male” and “female” for the attribute “gender”), however, actually, each individual item is a not just an attribute value, but is a combination of an attribute and attribute value; for example, an item is expressed as “gender”=“male”, so it is possible to determine whether or not an item is an attribute value of a masked attribute. In other words, the “male” portion is masked, however, the “gender” portion is not masked.

When I is not an attribute value of an attribute to be masked, the unmask processing unit 39 sets I_{i,j} for 1 (step S45). When the attribute is not an attribute to be masked, that attribute value does not have to be unmasked. After that, the processing moves to step S51.

On the other hand, when I_{i,j} is an attribute value of an attribute to be masked, the unmask processing unit 39 identifies the mask value of the attribute relating to I_{i,j} in Mask[s] and sets the identified value for M (step S47). As was described above, when it is known that I_{i,j} is an attribute value of which attribute to be masked, it is also possible to identify the corresponding mask value.

The unmask processing unit 39 then unmasks I_{i,j} with M, and sets the unmasked value for 1 (step S49). In other words, I=f⁻¹(I_{i,j},M)=f⁻¹(f(Data,M),M)=Data. However, this is a case where the correct mask value set is applied.

After that, the unmask processing unit 39 adds I to the set Dᵢ (step S51). Then, the unmask processing unit 39 increments j by “1” (step S53), and determines whether j is equal to or less than jmax, which is the maximum value of j (step S55). When j is equal to or less than jmax, the processing returns to the step S41 by way of terminal B. On the other hand, when j is greater than jmax, the unmask processing unit 39 increments i by “1”, and initializes j to “1” (step S57). The unmask processing unit 39 then determines whether i is equal to or less than U (step S59). When i is equal to or less than U, the processing returns to the step S39 by way of terminal C. However, when i is greater than U, the unmask processing unit 39 stores the set Dᵢ in the unmasked analysis data storage unit 40 (step S61). The result obtained by sorting the sets Dᵢ according to the frequency of appearance of the set Dᵢ may be stored. The data that is stored in the unmasked analysis data storage unit 40 is provided to the user in response to an instruction from the user. The processing then ends.

In this way, in this embodiment, it is unclear by which mask value set an item set Cᵢ included in the analysis data is masked. Therefore, the unmasking is performed using the mask value set having the highest frequency of appearance. The effectiveness of this kind of processing will be explained in more detail below.

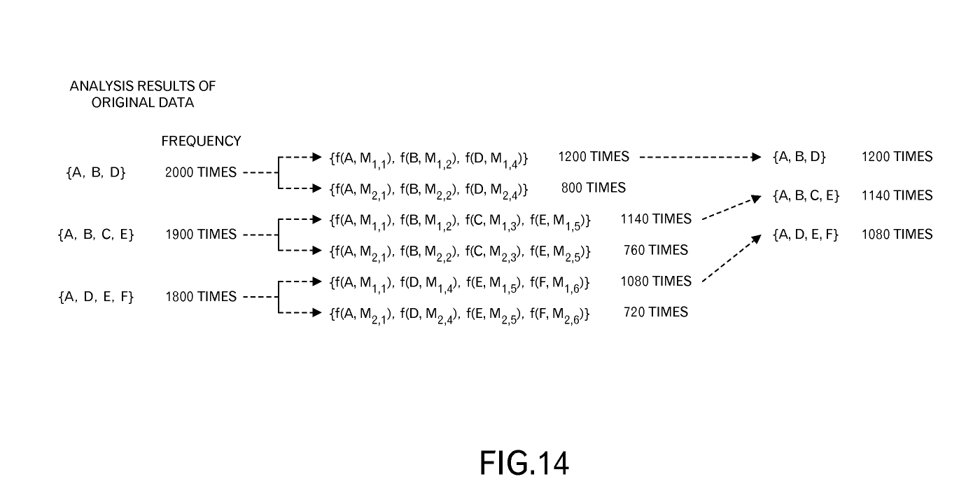

As illustrated on the left side of FIG. 14, as a result of analyzing the original data using the Apriori algorithm, it is presumed that item set {A B, D} was detected 2000 times, item set {A, B, C, E} was detected 1900 times, and item set {A, D, E, F} was detected 1800 times. Moreover it is assumed that, two mask value sets are used, with the appearance ratio of Mask [1]={M_{1,1}, M_{1,2}, . . . M_{1,k}} being 0.6, and the appearance ratio of Mask [2]={M_{2,1}, M_{2,2}, . . . M_{2,k}} being 0.4.

In such a case, the analysis result for the masked data is detected in the form {f(A, M_{1,1}), f(B, M_{1,2}), f(D, M_{1,4})} or detected in the form {f(A, M_{2,1}), f(B, M_{2,2}), f(D, M_{2,4})} for {A, B, D} as illustrated in the center of FIG. 14. In the case of appearance ratios for the mask value sets described above, the former is detected roughly 1200 times, and the latter is detected 800 times.

Similarly, the analysis result for the masked data is detected in the form {f(A, M_{1,1}), f(B, M_{1,2}), f(C, M_{1,3}), f(E, M_{1,5})} or detected in the form {f(A, M_{2,1}), f(B, M_{2,2}) f(C, M_{2,3}), f(E, M_{2,5})} for {A, B, C, E}. In the case of appearance ratios for the mask value sets described above, the former is detected roughly 1140 times, and the latter is detected 760 times.

Furthermore, the analysis result for the masked data is detected in the form {f(A, M_{1,1}), f(D, M_{1,4}), f(E, M_{1,5}), f(F, M_{1,6})} or detected in the form {f(A, M_{2,1}), f(D, M_{2,4}), f(E, M_{2,5}), f(F, M_{2,6})} for {A, D, E, F}. In the case of appearance ratios for the mask value sets described above, the former is detected roughly 1080 times, and the latter is detected 720 times.

In this way, when there is bias in the frequency of appearance of the mask value sets in the masking stage and the frequency of appearance of Mask [1] is high, the order of the frequency of appearance of the masked analysis data that is masked by Mask [1] is maintained even in the masked analysis data (for example, the item sets). Therefore, when using Mask [1] to unmask the masked analysis data having a high frequency of appearance (here, this is U=3) among the masked analysis data (for example, item sets), proper results are obtained such as illustrated on the right side of FIG. 14. The correct value of the frequency of appearance is not obtained, however the order is the same, which is sufficient for understanding the trend of the data. There is a possibility that a certain amount of fluctuation will also occur in the order depending on the bias of the frequency of appearance of the mask value sets, however, the result is sufficient for understanding the trend of the data.

By performing the processing such as described above, it is possible to perform the analysis processing while the data is being masked, and it is possible to adequately unmask the analysis results to use the analysis results.

In the above explanation, unmasking is performed after firstly narrowing down the data to U item sets, however, as long as the values of the frequency of appearance are correlated and saved, the top U item sets may be selected after unmasking and sorting according to the value of the frequency of appearance.

### Embodiment 2

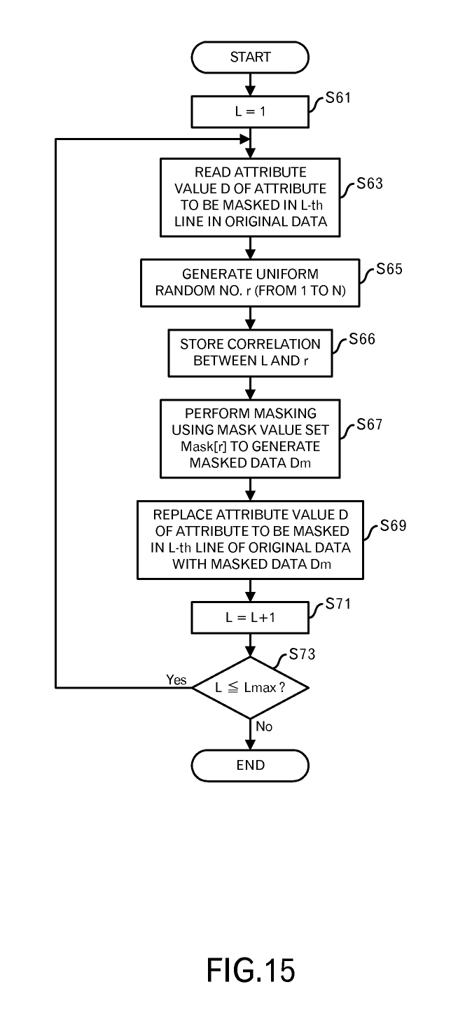

Next, a second embodiment will be explained using FIG. 15 to FIG. 19. The overall system configuration, the configurations of the analysis apparatus 51 and the database 53 in the cloud computing environment 5, and the configuration of the user apparatus 3 are the same as in the first embodiment, so an explanation is omitted. Moreover, the contents of the initial processing are the same as that explained in FIG. 10, so an explanation is omitted.

Next, the masking process relating to this embodiment will be explained using FIG. 15.

First, the mask processing unit 34 initializes L, which is a counter of the records included in the original data stored in the data storage unit 32, to “1” (step S61). The mask processing unit 34 then reads attribute values D of the attributes to be masked in the L-th line of the original data from the data storage unit 32 (step S63). As described above, there are k attributes to be masked, so values D={Data_{L,1}, Data_{L,2}, . . . Data_{L,k}} are read.

The mask processing unit 34 also generates a uniform random number r within the range from 1 to N (step S65). Differing from the first embodiment, in this embodiment, a random number is generated so that the frequency of appearance becomes uniform. The mask processing unit 34 then stores the correlation between L and r in the data storage unit 32 as mask selection data (step S66). As a result, it becomes possible to restore the original data.

Furthermore, the mask processing unit 34 generates masked data Dm by performing masking D using the mask value set Mask[r] (step S67). Mask[r]={L_{r,1},M_{r,2}, . . . M_{r,k}} is read from the mask data storage unit 35, and Dm={f(Data_{L,1},M_{r,1}),f(Data_{L,2},M_{r,2}), . . . f(Data_{L,k},M_{r,k})} is generated.

In this embodiment, the function f(x, y)=z is a function in which the relationship between x and z is a bijection relationship, and satisfies the relationship f(a, b)≠f⁻¹(a, b). In other words, addition, addition and remainder, multiplication, multiplication and remainder, subtraction, and subtraction and remainder can be used, however, exclusive OR cannot be used. The reason for this will be explained in the explanation of the unmask process. The other portions of this embodiment are the same as in the first embodiment.

After that, the mask processing unit 34 replaces the attribute values D of the attributes to be masked on the L-th line of the original data in the data storage unit 32 with the masked data Dm (step S69). Here, the case in which the original data is not saved inside the user apparatus 3 is given, however, when the original data is saved, then the masked data and attribute values of attributes other than attributes to be masked are stored in a separate area at the step S69. After that, the mask processing unit 34 increments L by “1” (step S71), and determines whether or not L is equal to or less than the number of records Lmax of the original data (step S73). When L is equal to or less than Lmax, the processing returns to the step S63. However, when L is greater than Lmax, the processing ends.

The analysis processing is a processing according to the Apriori algorithm, for example, so an explanation is omitted here. In other words, the analysis processing is performed with the data masked as was done conventionally, so the analysis results are being masked.

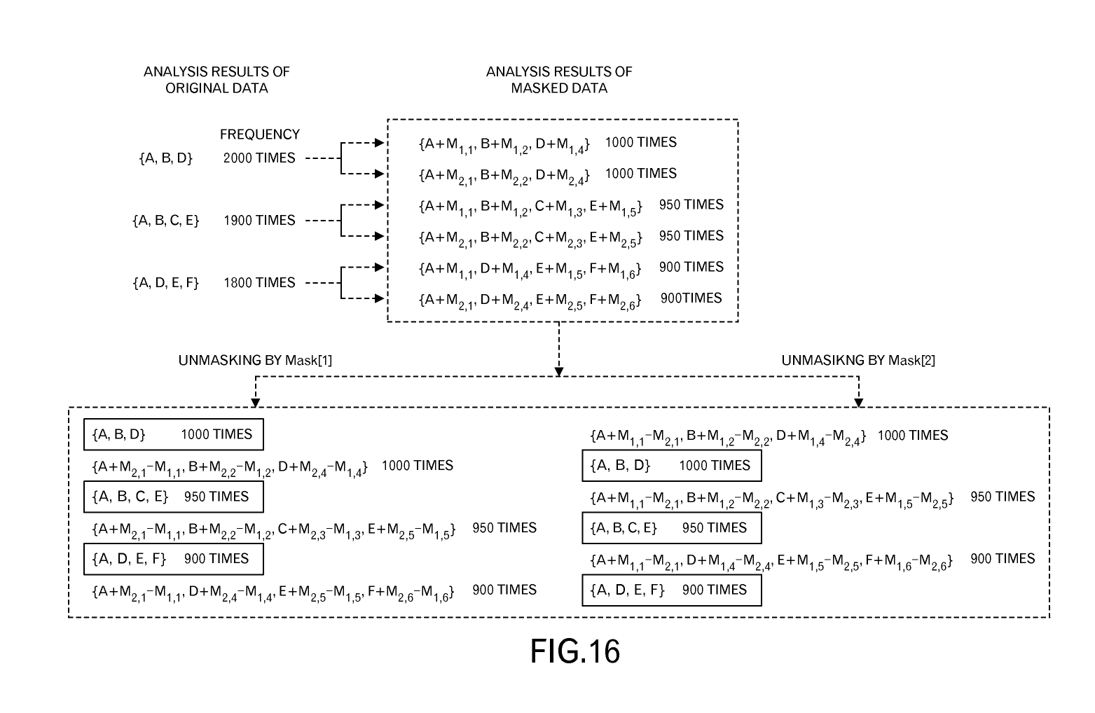

Next, the unmask processing will be explained using FIG. 16 to FIG. 19. Here, first, the differences from the first embodiment will be explained using a specific example. Similar to FIG. 14, as a result of analyzing the original data using the Apriori algorithm, item set {A, B, D} was detected 2000 times, item set {A, B, C, E} was detected 1900 times and item set {A, D, E, F} was detected 1800 times. Moreover, two mask value sets were used, where the appearance ratio of Mask [1]={M_{1,1}, M_{1,2}, . . . M_{1,k}} is 0.5, and the appearance ratio of Mask [2]={M_{2,1}, M_{2,2}, . . . M_{2,k}} is 0.5. In other words, the appearance frequencies are the same.

In such a case, as illustrated on the right side of FIG. 16, the analysis result of the masked data is detected in the form {A+M_{1,1}, B+M_{1,2}, D+M_{1,4}}, or detected in the form {A+M_{2,1}, B+M_{2,2}, D+M_{2,4}} for {A, B, D}. Addition is used for the masking operation. In the case of appearance ratios for the mask value sets described above, the former is detected roughly 1000 times, and the latter is detected 1000 times.

Similarly, the analysis result for the masked data is detected in the form {A+M_{1,1}, B+M_{1,2}, C+M_{1,3}, E+M_{1,5}} or detected in the form {A+M_{2,1}, B+M_{2,2}, C+M_{2,3}, E+M_{2,5}} for {A, B, C, E}. In the case of appearance ratios for the mask value sets described above, the former is detected roughly 950 times, and the latter is detected 950 times.

Furthermore, the analysis result for the masked data is detected in the form {A+M_{1,1}, D+M_{1,4}, E+M_{1,5}, F+M_{1,6}} or detected in the form {A+M_{2,1}, D+M_{2,4}, E+M_{2,5}, F+M_{2,6}} for {A, D, E, F}. In the case of appearance ratios for the mask value sets described above, the former is detected roughly 900 times, and the latter is detected 900 times.

In this way, in case where there is no bias in the frequency of appearance of the mask value sets, when it is not possible to perform the unmasking correctly, correct analysis results cannot be obtained. However, it is unclear which mask value sets are used for which masked analysis data (for example, item sets).

Therefore, in this embodiment, each mask value set is used for all of the masked analysis data (for example, item sets).

Here, there are two mask value sets, so the unmasking is performed by using the two mask value sets on each of the three item sets, and when the same unmasking results are obtained, the frequency of appearance thereof is totaled and used as the final analysis result. When the correct mask value sets are used, the correct item sets are restored, and when incorrect mask value sets are used, incorrect item sets are restored. However, originally, the masking is performed by using one of the mask value sets, so when all mask value sets are used, the correct item sets are restored N times, however, when the incorrect mask value sets are used, identical item sets are not generated and cannot be aggregated. Therefore, the correct analysis results for item sets having a high frequency of appearance rise to the top.

As illustrated on the bottom of the left side of FIG. 16, when Mask [1]={M_{1,1}, M_{1,2}, . . . M_{1,k}} is applied, the results given below are obtained.

{A+M_{1,1}−M_{1,1}, B+M_{1,2}−M_{1,2}, D+M_{1,4}−M_{1,4}}={A, B, D} (1000 times) {A+M_{2,1}−M_{1,1},B+M_{2,2}−M_{1,2},D+M_{2,4}−M_{1,4}} (1000 times) The unmasking is failed. {A+M_{1,1}−M_{1,1},B+M_{1,2}−M_{1,2},C+M_{1,3}−M_{1,3},E+M_{1,5}−M_{1,5}}={A,B,C,E} (950 times) {A+M_{2,1}−M_{1,1},B+M_{2,2}−M_{1,2},C+M_{2,3}−M_{1,3},E+M_{2,5}−M_{1,5}} (950 times) The unmasking is failed. {A+M_{1,1}−M_{1,1},D+M_{1,4}−M_{1,4},E+M_{1,5}−M_{1,5},F+M_{1,6}−M_{1,6}}={A,D,E,F} (900 times) {A+M_{2,1}−M_{1,1},D+M_{2,4}−M_{1,4},E+M_{2,5}−M_{1,5},F+M_{2,6}−M_{1,6}} (900 times) The unmasking is failed. As illustrated on the bottom of the right side of FIG. 16, when Mask [2]={M_{2,1}, M_{2,2}, . . . M_{2,k}} is applied, the results given below are obtained. {A+M_{1,1}−M_{2,1},B+M_{1,2}−M_{2,2},D+M_{1,4}−M_{2,4}} (1000 times) The unmasking is failed. {A+M_{2,1}−M_{2,1},B+M_{2,2}−M_{2,2},D+M_{2,4}−M_{2,4}}={A,B,D} (1000 times) {A+M_{1,1}−M_{2,1},B+M_{1,2}−M_{2,2},C+M_{1,3}−M_{2,3},E+M_{1,5}−M_{2,5}} (950 times) The unmasking is failed. {A+M_{2,1}−M_{2,1},B+M_{2,2}−M_{2,2},C+M_{2,3}−M_{2,3},E+M_{2,5}−M_{2,5}}={A,B,C,E} (950 times) {A+M_{1,1}−M_{2,1},D+M_{1,4}−M_{2,4},E+M_{1,5}−M_{2,5},F+M_{1,6}−M_{2,6}} (900 times) The unmasking is failed. {A+M_{2,1}−M_{2,1},D+M_{2,4}−M_{2,4},E+M_{2,5}−M_{2,5},F+M_{2,6}−M_{2,6}}={A,D,E,F} (900 times)

When the aforementioned results are totaled, the results 2000 times for {A, B, D}, 1900 times for {A, B, C, E} and 1800 times for {A, D, E, F} are obtained, and the same results are obtained as in the case when the Apriori algorithm is applied to the original data.

At the step S65, generation of uniform random numbers was described, however, even in the case of non-uniform random numbers, by performing the processing such as described above, correctly unmasked item sets are summarized, so the result of 2000 times for {A, B, D} is the same, and when the unmasking fails, only variation in the frequency of appearance occurs.

Furthermore, as was described above, in this embodiment, an exclusive OR cannot be used. In other words, f(a, b)≠f⁻¹(a, b) is a condition.

In the example of {A, B, D} used above, {A, B, D} is detected 2000 times, however, when the unmasking failed, incorrect item set was only detected 1000 times, so it can be seen that {A, B, D} is correct. {A+M_{1,1}−M_{2,1},B+M_{1,2}−M_{2,2},D+M_{1,4}−M_{2,4}} (1000 times) The unmasking failed. {A+M_{2,1}−M_{1,1},B+M_{2,2}−M_{1,2},D+M_{2,4}−M_{1,4}} (1000 times) The unmasking failed.

However, in the case of f(a, b)=a XOR b, and f⁻¹ (a, b)=a XOR b, a result such as given below is obtained. {A, B, D} 2000 times {A XOR M_{1,1}XOR M_{2,1},B XOR M_{1,2} XOR M_{2,2},D XOR M_{1,4}XOR M_{2,4}} (1000 times) The unmasking failed. {A XOR M_{2,1}XOR M_{1,1},B XOR M_{2,2}XOR M_{1,2},D XOR M_{2,4}XOR M_{1,4}} (1000 times) The unmasking failed.

As described above, when the cases in which the unmaking failed are summarized, the frequency of appearance become 2000 times, so a distinction cannot be made. Therefore, it is not possible to use an exclusive OR.

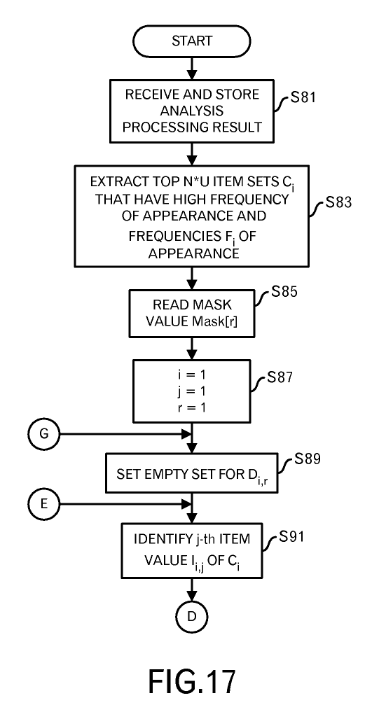

In order to perform such a processing, the processing such as illustrated in FIG. 17 to FIG. 19 is performed. First, the data receiver 36 receives analysis data that is the analysis processing result from the analysis apparatus 51, and stores the received data in the analysis data storage unit 37 (step S81). The analysis data is masked as is, and in the case of using the Apriori algorithm, includes item sets and the frequency of appearance data thereof.

Then, the unmask processing unit 39 extracts the top N*U item sets Cᵢ having a high frequency of appearance and the frequencies of appearance Fi from among the analysis data that are stored in the analysis data storage unit 37 (step S83). The item sets Cᵢ are expressed as below.

C₁={I_{1,1},I_{1,2}, . . . I_{1,max}_{_{—}}₁}

C₂={I_{2,1},I_{2,2}, . . . I_{2,max}_{_{—}}₂}

C_{U}={I_{U*N,1},I_{U*N,2}, . . . I_{U*N,max}_{_{—}}_{U}}

When there is N mask value sets, the number of item sets increases N times, so taking this into consideration, N*U item sets are extracted.

The unmask processing unit 39 also reads mask value sets Mask[r] (r=1 to N) that are stored in the mask data storage unit 35 (step S85). In this embodiment, N mask value sets are used, so all N mask value sets are read.

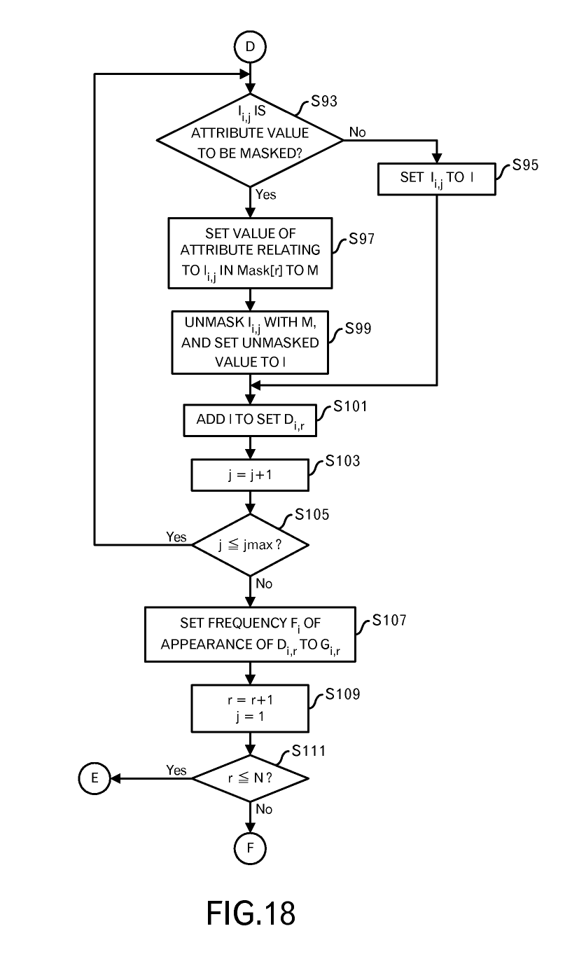

Moreover, the unmask processing unit 39 also initializes a counter for the item set, counter j for the item, and counter r for the mask value set to “1” (step S87). Furthermore, the unmask processing unit 39 sets an empty set for unmask analysis data D_{1,r} (step S89). The unmask processing unit 39 identifies the j-th item value I_{i,j} of the item set Cᵢ (step S91). The processing then moves to the processing in FIG. 18 by way of terminal D.

Moving to an explanation of the processing in FIG. 18, the unmask processing unit 39 determines whether or not I_{i,j} is an attribute value of an attribute to be masked (step S93). Similarly to the step S43, it is presumed that it is possible to determine whether or not I_{i,j} is an attribute value of an attribute to be masked.

When I_{i,j} is not an attribute value of an attribute to be masked, the unmask processing unit 39 stets I_{i,j} for 1 (step S95). This is because when the attribute value is not of an attribute to be masked, that attribute value does not need to be unmasked. After that, the processing moves to step S101.

On the other hand, when I_{i,j} is an attribute value of an attribute to be masked, the unmask processing unit 39 identifies the mask value of the attribute relating to I_{i,j} in the Mask[r], and sets that value for M (step S97). As was also described above, when it is known that is an attribute value of which attribute to be masked, it is possible to identify the corresponding mask value.

The unmask processing unit 39 then unmasks I_{i,j} with M, and sets the unmasked value for 1 (step S99). In other words, I=f⁻¹(I_{i,j},M)=f⁻¹(f(Data,M),M)=Data. However, it is not possible to determine whether the unmasking succeeded or failed.

After that, the unmask processing unit 39 adds I to the set D_{1,r} (step S101). The unmask processing unit 39 then increments j by “1” (step S103), and determines whether or not j is equal to or less than the maximum value jmax of j (step S105). When j is equal to or less than jmax, the processing returns to the step S93. However, when j is greater than jmax, the unmask processing unit 39 sets the frequency of appearance Fi of D_{i,r} for the frequency G_{i,r} (step S107). When i is the same even though r changes, the same value is set, and this condition is illustrated at the bottom in FIG. 16 where the same value is set on the left and right.

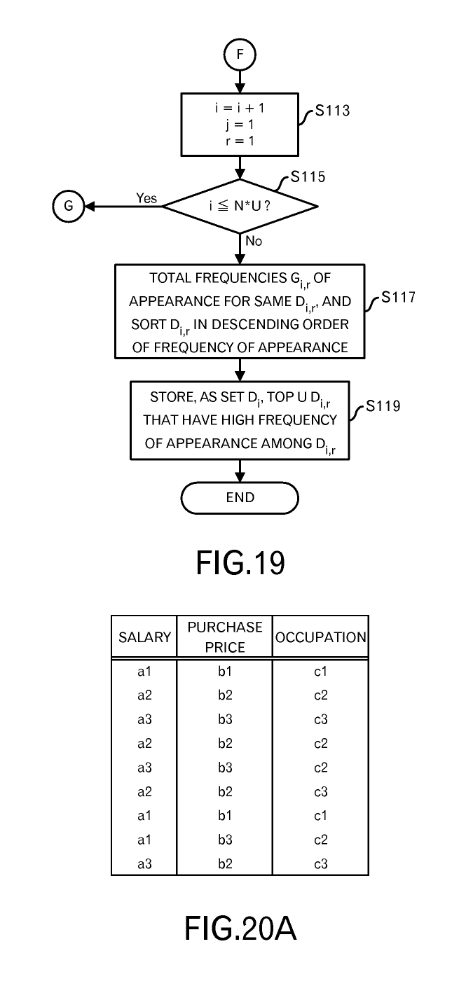

The unmask processing unit 39 then increments r by “1” and initializes j to “1” (step S109). After that, the unmask processing unit 39 determines whether or not r is equal to or less than N (step S111). When r is equal to or less than N, the processing returns to the step S91 by way of terminal E. However, when r is greater than N, the processing moves to the processing in FIG. 19 by way of terminal F.

Moving to an explanation of the processing in FIG. 19, the unmask processing unit 39 increments i by “1” and initializes j and r to “1” (step S113). Furthermore, the unmask processing unit 39 determines whether i is equal to or less than N*U (step S115). When i is equal to or less than N*U, the processing returns to the step S89 by way of terminal G. However, when i is greater than N*U, the unmask processing unit 39 totals the frequency of appearance G_{i,r} for the same D_{i,r}, and sorts the frequencies of appearance in the descending order of the frequency of appearance (step S117).

Then, the unmask processing unit 39 stores the top U item sets (in some cases, the number of item sets, which is determined by a predetermined ratio from the top) from among the having a high frequency of appearance as the set D of an analysis result in the unmasked analysis data storage unit 40 (step S119). In the example described above, {A, B, D}, {A, B, C, E} and {A, D, E, F} are stored in the unmasked analysis data storage unit 40. The data that is stored in the unmasked analysis data storage unit 40 is presented to the user in response to an instruction from the user.

By performing the processing such as described above, constraints on random numbers that are generated in order to select mask value sets in the masking process are eliminated, and it further becomes possible to obtain accurate analysis results.

### Embodiment 3

As was described above, the analysis processing may be a tabulation processing instead of the processing based on the Apriori algorithm. The tabulation processing is a simple processing, and the meaning of the analysis results are very easy for a person to understand, so it is one analysis method that is very widely used. Especially, cross tabulation for finding the frequency of combinations of two attributes is very widely used as a method for making it easy to visualize the correlation between two attributes that are included in data.

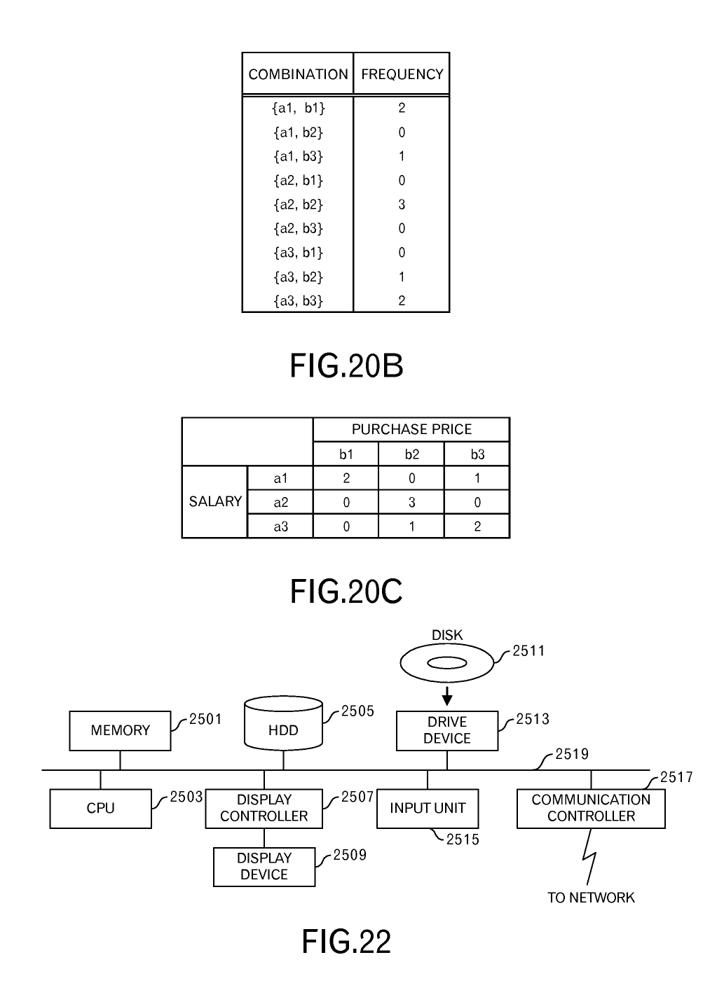

An example of typical cross tabulation is illustrated in FIG. 20A to FIG. 20C. In FIG. 20A, an example is illustrated in which each of the attributes, salary, purchase price and occupation, have three values. In other words, salary is categorized into the values a1, a2 and a3, purchase price is categorized Into the values b1, b2 and b3, and occupation is categorized into the values c1, c2 and c3, and it is possible to visualize the correlation between attributes by cross tabulation. As illustrated in FIG. 20B, when performing the cross tabulation of “salary” and “purchase price”, the frequencies of appearance of the combinations of these two attributes, which are {a1, b1}, {a1, b2}, {a1, b3}, {a2, b1}, {a2, b2}, {a2, b3}, {a3, b1}, {a3, b2} and {a3, b3}, are counted and data such as illustrated in FIG. 20B is obtained. When put into easy to view in a table format, a table such as illustrated in FIG. 20C is obtained.

In the case of this kind of cross tabulation, as in the case of the Apriori algorithm, the frequencies of appearance of the combinations of items are calculated, however, the following points differ from the Apriori algorithm.

(a) Counting the frequency of appearance of a combination of two items In the Apriori algorithm, the combinations of an arbitrary number of items are counted depending on the setting.

(b) Displaying the count results for all of the combinations having a high or low frequency of appearance

In the Apriori algorithm, the counting results for only items having a predetermined frequency of appearance or greater are kept.

There are differences such as described above, however, in the end, the frequency of appearance of two items is tabulated in the cross tabulation.

The basic processing contents when performing this kind of cross tabulation are similar to those in the second embodiment. In other words, the initial processing is the same as in the first embodiment, and the masking processing is the same as in the second embodiment. However, the unmasking processing differs in only step S83 in FIG. 17. In other words, at the step S83, the top N*U item sets having a high frequency of appearance are extracted, however, in the case of the cross tabulation, all of the results are used, so the extraction processing is not performed, and all of the results are used as they are.

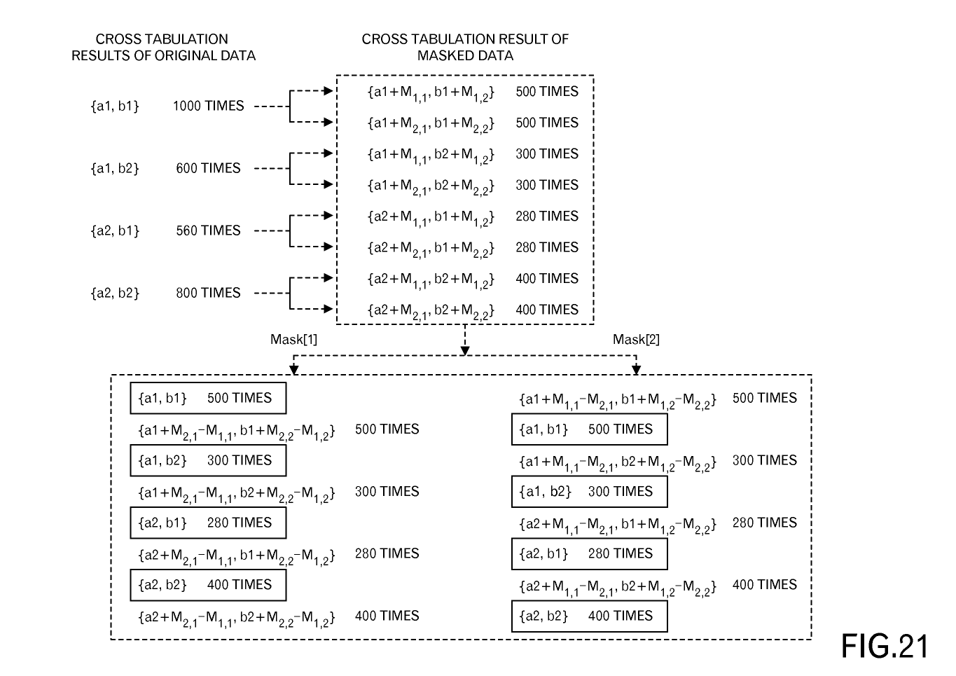

An outline of the unmasking processing in this embodiment will be explained using FIG. 21. For example, as illustrated on the left side of FIG. 21, when performing the cross tabulation for the original data, {a1, b1} is obtained 1000 times, {a1, b2} is obtained 600 times, {a2, b1} is obtained 560 times and {a2, b2} is obtained 800 times. Two mask value sets are used, where Mask[1]={M_{1,1},M_{1,2}} has an appearance ratio of 0.5 and Mask[2] {M_{2,1}, M_{2,2}} has an appearance ratio of 0.5. In other words, the frequencies of appearance are the same.

On the other hand, results of the cross tabulation processing for the masked data such as illustrated on the right side of FIG. 21 are obtained. In other words, {a1+M_{1,1},b1+M_{1,2}} is detected 500 times, {a1+M_{2,1},b1+M_{2,2}} is detected 500 times, {a1+M_{1,1},b2+M_{1,2}} is detected 300 times, {a1+M_{2,1},b2+M_{2,2}} is detected 300 times, {a2+M_{1,1},b1+M_{1,2}} is detected 280 times, {a2+M_{2,1},b1+M_{2,2}} is detected 280 times, {a2+M_{1,1},b2+M_{1,2}} is detected 400 times, and {a2+M_{2,1},b2+M_{2,2}} is detected 400 times.

Similarly to the second embodiment, it is unclear which of the mask value sets is applied, so as illustrated at the bottom of FIG. 21, each mask value set is applied to each of the attribute value combinations. This will be described in more detail below.

In other words, as illustrated on the left side at the bottom of FIG. 21, when Mask [1]={M_{1,1},M_{1,2}} is applied, a result such as below is obtained. {a1+M_{1,1}−M_{1,1},b1+M_{1,2}−M_{1,2}}={a1,b1} (500 times) {a1+M_{2,1}−M_{1,1},b1+M_{2,2}−M_{1,2}} (500 times) The unmasking is failed. {a1+M_{1,1}−M_{1,1},b2+M_{1,2}−M_{1,2}}={a1,b2} (300 times) {a1+M_{2,1}−M_{1,1},b2+M_{2,2}−M_{1,2}} (300 times) The unmasking is failed. {a2+M_{1,1}−M_{1,1},b1+M_{1,2}−M_{1,2}}={a2,b1} (280 times) {a2+M_{2,1}−M_{1,1},b1+M_{2,2}−M_{1,2}} (280 times) The unmasking is failed. {a2+M_{1,1}−M_{1,1},b2+M_{1,2}−M_{1,2}}={a2,b2} (400 times) {a2+M_{2,1}−M_{1,1},b2+M_{2,2}−M_{1,2}} (400 times) The unmasking is failed.

As illustrated on the right side at the bottom of FIG. 21, when Mask [2]={M_{2,1}, M_{2,2}} is applied, a result such as below is obtained. {a1+M_{1,1}−M_{2,1},b1+M_{1,2}−M_{2,2}} (500 times) The unmasking is failed. {a1+M_{2,1}−M_{2,1},b1+M_{2,2}−M_{2,2}}={a1,b1} (500 times) {a1+M_{1,1}−M_{2,1},b2+M_{1,2}−M_{2,2}} (300 times) The unmasking is failed. {a1+M_{2,1}−M_{2,1},b2+M_{2,2}−M_{2,2}}={a1,b2} (300 times) {a2+M_{1,1}−M_{2,1},b1+M_{1,2}−M_{2,2}} (280 times) The unmasking is failed. {a2+M_{2,1}−M_{2,1},b1+M_{2,2}−M_{2,2}}={a2,b1} (280 times) {a2+M_{1,1}−M_{2,1},b2+M_{1,2}−M_{2,2}} (400 times) The unmasking is failed. {a2+M_{2,1}−M_{2,1},b2+M_{2,2}−M_{2,2}}={a2,b2} (400 times)

By tabulating the results above, results of 1000 times for {a1, b1}, 600 times for {a1, b2}, 560 times for {a2, b1} and 800 times for {a2, b2} are obtained. The same result as that in case where the cross tabulation processing is performed for the original data is obtained.

In this case as well, at the step S65, generating uniform random numbers was described, however, by performing the processing described above even in the case of non-uniform random numbers, correct unmasked attribute value combinations are aggregated, so the result of 1000 times for {a1, b1} is the same, and in the case where the unmasking is failed, only variation in the frequency of appearance occurs.

Although the embodiments of this technique were explained, this technique is not limited to those. For example, the functional block diagrams illustrated in FIGS. 8 and 9 are mere examples, and may not be always correspond to actual program module configurations. Moreover, as for the processing flows, as long as the processing results do not change, the turns of the steps may be exchanged, and plural steps may be executed in parallel.

In addition, the aforementioned user apparatuses 3 and 7 and an analysis apparatus 51 are computer devices as illustrated in FIG. 22. That is, a memory 2501 (storage device), a CPU 2503 (processor), a hard disk drive (HDD) 2505, a display controller 2507 connected to a display device 2509, a drive device 2513 for a removable disk 2511, an input device 2515, and a communication controller 2517 for connection with a network are connected through a bus 2519 as illustrated in FIG. 22. An operating system (OS) and an application program for carrying out the foregoing processing in the embodiment, are stored in the HDD 2505, and when executed by the CPU 2503, they are read out from the HDD 2505 to the memory 2501. As the need arises, the CPU 2503 controls the display controller 2507, the communication controller 2517, and the drive device 2513, and causes them to perform predetermined operations. Moreover, intermediate processing data is stored in the memory 2501, and if necessary, it is stored in the HDD 2505. In this embodiment of this technique, the application program to realize the aforementioned functions is stored in the computer-readable, non-transitory removable disk 2511 and distributed, and then it is installed into the HDD 2505 from the drive device 2513. It may be installed into the HDD 2505 via the network such as the Internet and the communication controller 2517. In the computer as stated above, the hardware such as the CPU 2503 and the memory 2501, the OS and the application programs systematically cooperate with each other, so that various functions as described above in details are realized.

The aforementioned embodiments are outlined as follows:

A data processing method relating to a first aspect of the embodiments includes: (A) generating a predetermined number of sets, and storing the generated data into a mask data storage unit, wherein each of the sets includes n mask values and n is the number of attributes to be masked in a database; (B) selecting, for each record of a plurality of records, which includes attribute values of the attributes to be masked, one set of the predetermined number of sets, which are stored in the mask data storage unit; and (C) performing, for each record of the plurality of records, a predetermined operation for the selected one set of the n mask values and the attribute values of the attributes to be masked in the record to generate masked data for the plurality of records, and storing the generated masked data into a data storage unit.

According to this processing, it becomes possible to generate the masked data while keeping the correlation among attributes in the record. Moreover, because data to restore original data from the masked data is only the selection result of the mask values, it is possible to reduce the data amount to restore the original data.

The aforementioned selecting may include: selecting one set of the predetermined number of sets by generating a random value from 1 to the predetermined number uniformly or according to distribution that has a predetermined peak. When the latter random numbers are used, it becomes possible to use a simplified unmasking processing to obtain simplified results.

Furthermore, the predetermined operation may be defined so that a relationship between an attribute value and an operation result is bijection. According to this operation, it is possible to restore the original data from the masked data.

A data processing method relating to a second aspect of the embodiments includes: (A) obtaining one set that has a highest appearance probability from among a predetermined number of sets, wherein each of the sets includes n mask values and n is the number of attributes to be masked in a database, and the predetermined number of sets are stored in a mask data storage unit; and (B) performing, for each of a plurality of analysis data sets, each of which includes masked attribute values, an inverse mask operation of a predetermined mask operation for a masked attribute value in the analysis data set and a corresponding mask value in the obtained one set, to generate unmasked data, and storing the generated unmasked data into a data storage unit.

By doing so, it becomes possible to obtain analysis results of the masked data at high-speed in a simplified form.

A data processing method relating to a third aspect of the embodiments includes: (A) performing, for each analysis data set of a plurality of analysis data sets, each of which includes masked attribute values, an inverse mask operation of a predetermined mask operation for the masked attribute values and corresponding mask values included in each set of a predetermined number of sets, each of which includes n mask values, wherein the n is the number of attributes to be masked in a database, to generate the predetermined number of unmasked analysis data sets for each of the plurality of analysis data sets, wherein the plurality of analysis data sets are stored in an analysis data storage unit, and the predetermined number of sets are stored in a mask data storage unit; (B) correlating each of the predetermined number of unmasked analysis data sets with an appearance frequency corresponding to the analysis data set used in the performing to generate the predetermined number of unmasked analysis data sets, and storing data concerning the correlation into an unmasked analysis data storage unit, wherein the appearance frequency is stored in the analysis data storage unit; (C) collecting same unmasked analysis data sets to sum appearance frequencies correlated with the same unmasked analysis data sets; and (D) storing data representing a type of the same unmasked analysis data sets and summed appearance frequencies in the unmasked analysis data storage unit.

By carrying out such a processing, it is possible to restore the correct analysis results.

In the data processing method relating to the second or third aspect of the embodiments, the plurality of analysis data sets may be selected in a descending order of the appearance frequency from among analysis data sets received from a computer that performed a analysis processing. Depending on the type of the analysis processing, it is preferable that the aforementioned selection is performed. Especially, in the case of the Apriori algorithm, the aforementioned selection may be carried out.

The predetermined operation may be defined so that a relationship between an attribute value and an operation result is bijection.

Incidentally, it is possible to create a program causing a computer to execute the aforementioned processing, and such a program is stored in a computer readable storage medium or storage device such as a flexible disk, CD-ROM, DVD-ROM, magneto-optic disk, a semiconductor memory, and hard disk. In addition, the intermediate processing result is temporarily stored in a storage device such as a Random Access Memory (RAM) or the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A computer-readable, non-transitory storage medium storing a program for causing a computer to execute a process, the process comprising:
generating a predetermined number of sets, wherein each of the sets includes n mask values and n is the number of attributes to be masked in a database;
selecting, for each record of a plurality of records, which includes attribute values of the attributes to be masked, one set of the predetermined number of sets; and
performing, for each record of the plurality of records, a predetermined operation for the selected one set of the n mask values and the attribute values of the attributes to be masked in the record to generate masked data for the plurality of records.

2. The computer-readable, non-transitory storage medium as set forth in claim 1, wherein the selecting comprises:
selecting one set of the predetermined number of sets by generating a random value from 1 to the predetermined number uniformly or according to distribution that has a predetermined peak.

3. The computer-readable, non-transitory storage medium as set forth in claim 1, wherein the predetermined operation is defined so that a relationship between an attribute value and an operation result is bijection.

4. A computer-readable, non-transitory storage medium storing a program for causing a computer to execute a process, the process comprising:
obtaining one set that has a highest appearance probability from among a predetermined number of sets, wherein each of the sets includes n mask values and n is the number of attributes to be masked in a database; and
performing, for each of a plurality of analysis data sets, each of which includes masked attribute values, an inverse mask operation of a predetermined mask operation for a masked attribute value in the analysis data set and a corresponding mask value in the obtained one set, to generate unmasked data.

5. A computer-readable, non-transitory storage medium storing a program for causing a computer to execute a process, the process comprising:
performing, for each analysis data set of a plurality of analysis data sets, each of which includes masked attribute values, an inverse mask operation of a predetermined mask operation for the masked attribute values and corresponding mask values included in each set of a predetermined number of sets, each of which includes n mask values, wherein the n is the number of attributes to be masked in a database, to generate the predetermined number of unmasked analysis data sets for each of the plurality of analysis data sets;
correlating each of the predetermined number of unmasked analysis data sets with an appearance frequency corresponding to the analysis data set used in the performing to generate the predetermined number of unmasked analysis data sets;
collecting same unmasked analysis data sets to sum appearance frequencies correlated with the same unmasked analysis data sets; and
storing data representing a type of the same unmasked analysis data sets and summed appearance frequencies.

6. The computer-readable, non-transitory storage medium as set forth in claim 4, wherein the plurality of analysis data sets are selected in a descending order of the appearance frequency from among analysis data sets received from a computer that performed a analysis processing.

7. The computer-readable, non-transitory storage medium as set forth in claim 4, wherein the predetermined mask operation is defined so that a relationship between an attribute value and an operation result is bijection.

8. A method, comprising:
generating, by using a computer, a predetermined number of sets, wherein each of the sets includes n mask values and n is the number of attributes to be masked in a database;
selecting, by using the computer and for each record of a plurality of records, which includes attribute values of the attributes to be masked, one set of the predetermined number of sets; and
performing, by using the computer and for each record of the plurality of records, a predetermined operation for the selected one set of the n mask values and the attribute values of the attributes to be masked in the record to generate masked data for the plurality of records.

9. An information processing apparatus, comprising:
a memory; and
a processor configured to use the memory and execute a process comprising:
generating a predetermined number of sets, wherein each of the sets includes n mask values and n is the number of attributes to be masked in a database;
selecting, for each record of a plurality of records, which includes attribute values of the attributes to be masked, one set of the predetermined number of sets; and
performing, for each record of the plurality of records, a predetermined operation for the selected one set of the n mask values and the attribute values of the attributes to be masked in the record to generate masked data for the plurality of records.

10. The computer-readable, non-transitory storage medium as set forth in claim 5, wherein the plurality of analysis data sets are selected in a descending order of the appearance frequency from among analysis data sets received from a computer that performed a analysis processing.
